(19) United States
(12) Patent Application Publication
(10) Pub. No.: US 2019/0193573 A1
(43) Pub. Date: Jun. 27, 2019

(54) TRAVELING ENERGY DISTRIBUTION SYSTEM, TRAVELING ENERGY DISTRIBUTION METHOD, AND TRAVELING ENERGY DISTRIBUTION PROGRAM

(71) Applicant: TOYOTA JIDOSHA KABUSHIKI KAISHA, Toyota-shi (JP)

(72) Inventors: Satoshi IWAI, Okazaki-shi (JP); Koji YAMADA, Toyota-shi (JP); Marie ISHIKAWA, Nagoya-shi (JP); Akinori SATO, Mishima-shi (JP); Hiroyuki YAMADA, Nagakute-shi (JP); Akira SHICHI, Nagakute-shi (JP); Masanori ISHIGAKI, Nagakute-shi (JP); Shuji TOMURA, Nagakute-shi (JP); Shigeaki GOTO, Nagakute-shi (JP); Hajime MURATA, Nagakute-shi (JP); Kenji ITO, Nagakute-shi (JP); Reiko MAKINO, Nagakute-shi (JP); Keisuke ICHIGE, Nagakute-shi (JP)

(73) Assignee: TOYOTA JIDOSHA KABUSHIKI KAISHA, Toyota-shi (JP)

(21) Appl. No.: 16/193,543

(22) Filed: Nov. 16, 2018

(30) Foreign Application Priority Data
Dec. 27, 2017 (JP) 2017-251869

(51) Int. Cl. B60L 11/18; G05B 15/02; H02J 3/38; G06Q 10/06; G06Q 50/06

(52) U.S. Cl. CPC B60L 11/1838; G05B 15/02; H02J 3/382; B60L 2230/22; G06Q 50/06; B60L 11/1881; B60L 2230/16; G06Q 10/06315

(57) ABSTRACT

A traveling energy distribution system includes a plurality of supply facilities each of which is able to supply traveling energy to a vehicle, an information acquisition unit configured to acquire, from a vehicle, vehicle information relevant to an amount of traveling energy remaining in the vehicle and acquire, from each of the plurality of supply facilities, supply facility information relevant to an amount of traveling energy that can be supplied from that supply facility, and a determination unit configured to determine a transfer source supply facility and a transfer destination supply facility for traveling energy to be transferred from among the plurality of supply facilities and determine an amount of the traveling energy to be transferred based on the vehicle information and the supply facility information acquired by the information acquisition unit.

### CROSS REFERENCE TO RELATED APPLICATIONS

This application is based upon and claims the benefit of priority from Japanese patent application No. 2017-251869, filed on Dec. 27, 2017, the disclosure of which is incorporated herein in its entirety by reference.

### BACKGROUND

The present disclosure relates to an energy distribution system, an energy distribution method, and an energy distribution program.

An energy management system that manages an operating state of a power device including a storage battery connected to a power grid has been known (see, for example, International Patent Publication No. WO2015/129734).

### SUMMARY

The present inventors have found the following problem. In a situation where a large number of electric vehicles and fuel-cell vehicles come and go, it may be necessary to locally supply energy to these vehicles. It is possible to store an amount of energy corresponding to the maximum demand at all times. However, there are many problems, such as a need for huge facilities.

The present disclosure has been made to solve such problems and provides a technique for distributing necessary amounts of energy to places where energy is required according to energy demands from vehicles traveling in an area of interest.

A first exemplary aspect is a traveling energy distribution system including: a plurality of supply facilities each of which is able to supply traveling energy to a vehicle; an information acquisition unit configured to acquire, from a vehicle, vehicle information relevant to an amount of traveling energy remaining in the vehicle and acquire, from each of the plurality of supply facilities, supply facility information relevant to an amount of traveling energy that can be supplied from that supply facility; and a determination unit configured to determine a transfer source supply facility and a transfer destination supply facility for traveling energy to be transferred from among the plurality of supply facilities and determine an amount of the traveling energy to be transferred based on the vehicle information and the supply facility information acquired by the information acquisition unit.

A traveling vehicle continues to travel until the vehicle actually needs to be supplied with traveling energy. If a distribution system can acquire information about the vehicle, the distribution system can predict in which supply facility the vehicle will need to be supplied with traveling energy. Then, it is possible, when the amount of traveling energy stored in the predicted supply facility is small, to transfer traveling energy from other supply facilities to the predicted supply facility before the vehicle arrives at the predicted supply facility. By dynamically performing the above-described transfer of traveling energy according to the actual traffic situation in the area of interest, it is possible to distribute necessary amounts of energy to places where energy is required according to unevenly-distributed energy demands.

The above-described traveling energy distribution system may include a plurality of production facilities, each of the plurality of production facilities being configured to generate renewable energy for supplying traveling energy to at least one of the plurality of supply facilities. Even if plants that supply traveling energy to respective supply facilities are those which generate renewable energy and whose outputs are unstable, traveling energy can be interchanged among the supply facilities. Therefore, it is possible to actively adopt such plants.

That is, the above-described distribution system contributes to the promotion of renewable energy.

In this case, by having the information acquisition unit acquire, from each of the plurality of production facilities, production facility information relevant to an amount of renewable energy generated in that production facility, the determination unit can determine a transfer source production facility for traveling energy from among the plurality of production facilities and determine a transfer destination supply facility for the traveling energy from among the plurality of supply facilities based on the vehicle information, the supply facility information, and the production facility information acquired by the information acquisition unit. That is, if traveling energy can be directly supplied from a plant that generates renewable energy to a supply facility that does not have enough traveling energy, the generated traveling energy can be consumed without wasting it even when a storage capacity of the supply facility, which supplies the traveling energy, is small in an ordinary state.

Further, the above-described traveling energy distribution system may include a transfer facility configured to transfer traveling energy between a plurality of supply facilities, and the transfer facility may be further configured to transfer an amount of traveling energy determined by the determination unit from the transfer source supply facility determined by the determination unit to the transfer destination supply facility determined by the determination unit. If the transfer facility, which transfers traveling energy, can also be controlled directly from the distribution system, the whole system can be automated. Therefore, it is possible to transfer traveling energy more reliably.

In this case, the determination unit may predict a time at which the vehicle, whose vehicle information has been acquired, arrives at the transfer destination supply facility and determine a speed of the transfer of traveling energy by the transfer facility based on the predicted arrival time. Further, the transfer facility may transfer the traveling energy according to the transfer speed determined by the determination unit. When electric power is transferred and stored in a storage battery, the electric power is preferably transferred at a relatively low speed because, by doing so, the deterioration of the storage battery can be prevented or minimized. However, when there is not an enough time before a vehicle of interest arrives at a supply facility of interest, the storage battery can be quickly charged by increasing the transfer speed. By controlling the transfer speed according to the demand as described above, it is possible to extend the life of the system while satisfying the demand from customers.

Further, the above-described traveling energy distribution system may include an auxiliary supply facility installed in a transfer path through which the transfer facility transfers traveling energy, the auxiliary supply facility being capable of supplying traveling energy to a vehicle. Further, the transfer facility may be configured to supply traveling energy to the auxiliary supply facility. It is assumed that the transfer facility is installed along a road. Therefore, the transfer facility is preferably configured to supply traveling energy to a traveling vehicle in an emergency as an emergency measure in order to improve the traffic environment of the area of interest.

Further, in the above-described traveling energy distribution system, the information acquisition unit may be configured to further acquire, as the vehicle information, at least one of a current location, a destination, a traveling speed, a traveling distance per unit traveling energy, and history information relevant to supplies of traveling energy. If such information can be acquired, the distribution system can predict the demand for traveling energy more accurately.

Further, in the above-described traveling energy distribution system, each of the plurality of supply facilities may include a storage battery configured to store electric power as traveling energy. Further, each of the plurality of supply facilities may include a hydrogen tank configured to generate hydrogen as traveling energy by using electric power and store the generated hydrogen. By including the storage battery and/or the hydrogen tank as described above, when the vehicle of interest is an electric vehicle, the vehicle can be supplied with electric power from the storage battery. Further, when the vehicle of interest is a fuel-cell vehicle, the vehicle can be supplied with hydrogen from the hydrogen tank.

Further, in the above-described traveling energy distribution system, the plurality of supply facilities are preferably installed along a motorway. For example, when vehicles traveling on an expressway are the vehicles for which energy demands are predicted, the distribution system can be accurately operated.

Another exemplary aspect is a traveling energy distribution method including: a vehicle information acquisition step of acquiring, from a vehicle, vehicle information relevant to an amount of traveling energy remaining in the vehicle; a supply facility information acquisition step of acquiring, from each of a plurality of supply facilities capable of supplying traveling energy to a vehicle, supply facility information relevant to an amount of traveling energy that can be supplied from that supply facility; a determination step of determining a transfer source supply facility and a transfer destination supply facility for traveling energy to be transferred from among the plurality of supply facilities and determine an amount of the traveling energy to be transferred based on the acquired vehicle information and the supply facility information; and a transfer step of transferring traveling energy equivalent to the determined amount of the traveling energy from the transfer source supply facility to the transfer destination supply facility.

Another exemplary aspect is a traveling energy distribution program for causing a computer to execute: a vehicle information acquisition step of acquiring, from a vehicle, vehicle information relevant to an amount of traveling energy remaining in the vehicle; a supply facility information acquisition step of acquiring, from each of a plurality of supply facilities capable of supplying traveling energy to a vehicle, supply facility information relevant to an amount of traveling energy that can be supplied from that supply facility; a determination step of determining a transfer source supply facility and a transfer destination supply facility for traveling energy to be transferred from among the plurality of supply facilities and determine an amount of the traveling energy to be transferred based on the acquired vehicle information and the supply facility information; and a transfer step of transferring traveling energy equivalent to the determined amount of the traveling energy from the transfer source supply facility to the transfer destination supply facility.

Similarly to the first aspect, each of the above-described second third aspects can distribute necessary amounts of energy to places where energy is required according to unevenly-distributed energy demands.

According to the present disclosure, it is possible to provide a technique for distributing necessary amounts of energy to places where energy is required according to energy demands from vehicles traveling in an area of interest.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a conceptual diagram showing an electric power distribution system according to an embodiment;

FIG. 2 shows a configuration of a server;

FIG. 3 is an example of vehicle information acquired by the server;

FIG. 4 is an example of station information generated by the server;

FIG. 5 is an example of power plant information generated by the server;

FIG. 6 is an example of a transfer plan among charging stations;

FIG. 7 is an example of a transfer plan of electric power of a power plant;

FIG. 8 is a flowchart showing processes performed by the server;

FIG. 9 is a conceptual diagram showing another example of an electric power distribution system; and

FIG. 10 is a conceptual diagram showing another example of an electric power distribution system.

### DESCRIPTION OF EMBODIMENTS

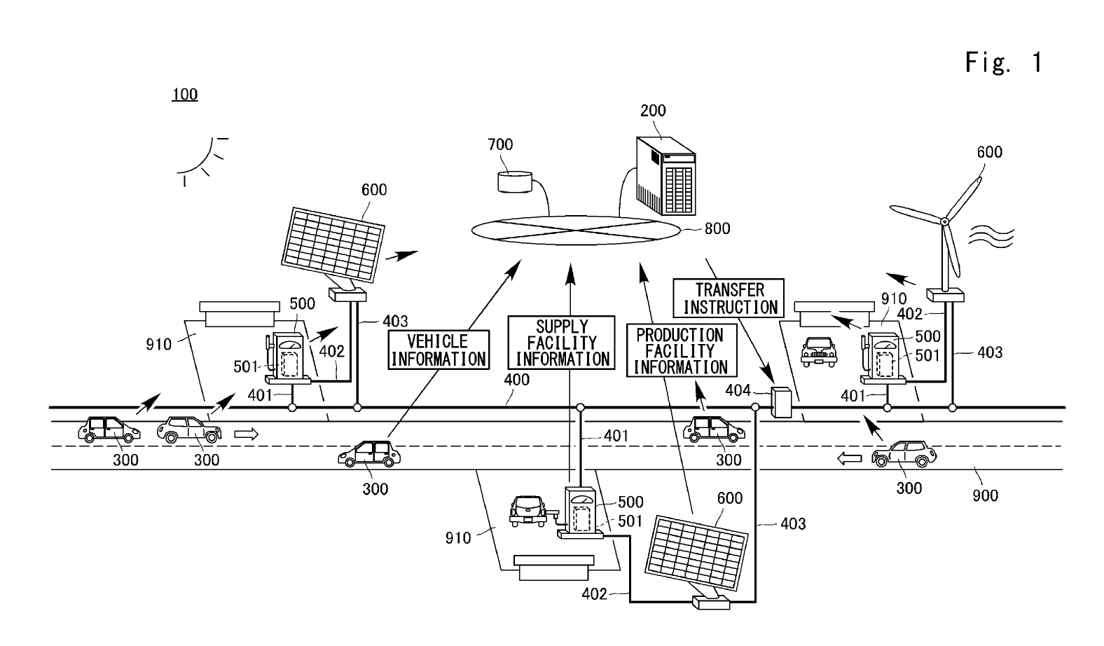

FIG. 1 is a conceptual diagram showing an electric power distribution system 100 according to an embodiment. The distribution system 100, which is described as a first example, is a system that distributes electric power as traveling energy according to the demand. The distribution system 100 sets a certain section of an expressway 900 as an area of interest (hereinafter also referred to as a target area). In the target area, a plurality of service areas 910 are provided along the expressway 900. Further, in each of the service areas 910, a charging station 500 that charges a rechargeable battery of a vehicle 300, which is an electric vehicle in the example, is provided. That is, the charging station 500 functions as a supply facility that supplies electric power to the vehicle 300.

The charging station 500 includes a storage battery 501 for temporarily storing electric power. Further, a power plant 600 is installed near each of the service areas 910. The charging station 500 and the nearest power plant 600 are electrically connected by a main power transmission line 402, and the storage battery 501 is charged mainly by electric power transmitted through the main power transmission line 402. The power plant 600 in this embodiment is, for example, a facility that generates electric power as renewable energy, such as a solar power generation facility and a wind power generation facility.

When the remaining amount of the rechargeable battery of the vehicle 300 traveling on the expressway 900 becomes small, the vehicle 300 stops at the service area 910, and is able to connect the rechargeable battery to the charging station 500 and thereby charge the rechargeable battery. The electric power with which the rechargeable battery of the vehicle 300 is charged may be electric power directly supplied from the power plant 600 or may be electric power stored in the storage battery 501.

Note that although FIG. 1 shows a state in which vehicles 300 that are target vehicles of the distribution system 100 are traveling on the expressway 900, other vehicles such as gasoline-driven cars may also travel on the expressway 900. Further, regarding electric vehicles, only vehicles having specific properties such as vehicles for which memberships are registered may be regarded as vehicles 300.

A power transmission line 400 and a control panel 404 are transfer facilities for transferring electric power. The power transmission line 400 is installed along the expressway 900. The power transmission line 400 and each of the charging stations 500 are electrically connected through a drop wire 401. The control panel 404 is a control unit that controls, for the transfer of electric power through the power transmission line 400, a transfer source of the electric power, a transfer destination of the electric power, and an amount of the electric power to be transferred. Under the control of the control panel 404, the power transmission line 400 can transfer electric power stored in the storage battery 501 of one of the charging stations 500 to the storage battery 501 of another charging station 500.

Further, the power transmission line 400 and each of the power plants 600 is electrically connected through a sub transmission line 403. Under the control of the control panel 404, the power transmission line 400 can transfer electric power generated by one of the power plants 600 to the storage battery 501 of a charging station 500 different from the charging station 500 connected to that power plant 600 by the main power transmission line 402.

Each vehicle 300 includes a processing unit and a communication interface. Further, each vehicle 300 creates vehicle information relevant to that vehicle and transmits the created vehicle information to a server 200. Further, each charging station 500 includes a processing unit and a communication interface. Further, each charging station 500 creates supply facility information relevant to an amount of electric power that the charging station 500 can supply and transmits the created supply facility information to the server 200. Further, each power plant 600 includes a processing unit and a communication interface. Further, each power plant 600 creates production facility information relevant to an amount of renewable energy that the power plant 600 generates and transmits the created production facility information to the server 200.

The server 200 acquires the vehicle information, the supply facility information, and the production facility information through an Internet network 800. Further, an external DB 700 is connected to the Internet network 800, and the server 200 acquires weather forecast information, such as information about weather and wind, stored in the external DB 700. The server 200 predicts an amount of generated electricity and a demand for electric power by using these information items. Then, the server 200 determines how much electric power should be transferred from which charging station to which charging station. That is, the server 200 determines a charging station that is expected to have an extra amount of stored electric power, a charging station where an amount of stored electric power is expected to be tight, and an amount of electric power that should be transferred between these charging stations.

Further, the server 200 determines how much electric power should be transferred from which power plant to which charging station. That is, the server 200 determines a power plant that is expected to have an extra amount of stored electric power, a charging station where an amount of stored electric power is expected to be tight, and an amount of electric power that should be transferred from the power plant to the charging station. The control panel 404 includes a communication IF (Interface) and is connected to the server 200 through the Internet network 800. The control panel 404 receives a transfer instruction in which information about the charging station and the power plant at the transfer source, the charge station at the transfer destination, and the amount of electric power to be transferred are described from the server 200, and performs the transfer of electric power according to the described content of the transfer instruction. The distribution system 100 transfers and distributes electric power to each of the charging stations 500 as described above and, by doing so, can cope with demands for electric power that could locally occur.

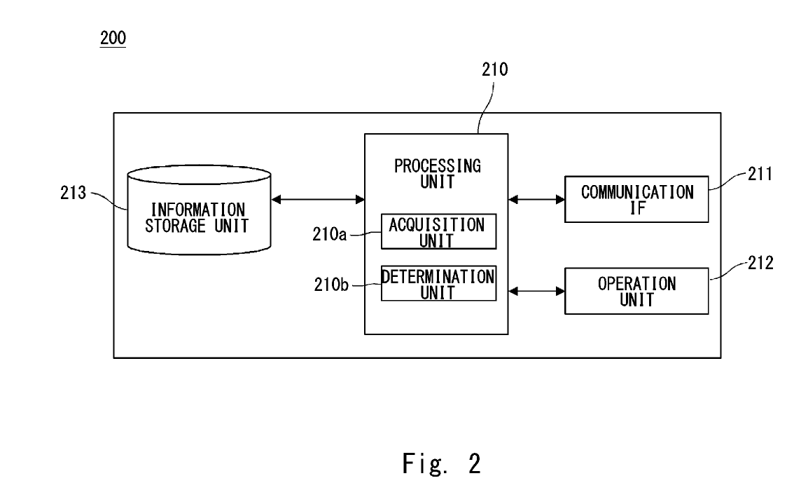

FIG. 2 shows a configuration of the server 200. A processing unit 210 is, for example, an MPU and controls the server 200 by executing a control program loaded from a system memory.

The communication IF 211 includes, for example, a wired LAN interface and is a communication interface for connecting with and communicating through the Internet network 800. The processing unit 210 receives the vehicle information, the supply facility information, and the production facility information through the communication IF 211 and transmits a transfer instruction to the control panel 404. An operation unit 212 is an input device, such as a keyboard and a mouse, connected to the server main unit. Further, the operation unit 212 is operated when a system administrator starts up or shuts down the system, adjusts parameter values, modifies programs, and the like.

An information storage unit 213 is, for example, a HDD (Hard Disk Drive), and stores various parameters and data and stores a database (DB) in which these parameters and data are systematically accumulated. Examples of information stored in the information storage unit 213 include a location of each charging station 500, information on the storage battery 501 provided in each charging station 500, a location and a power generating capability of each power plant 600, power generating performances of each power plant 600 in the past and information on weathers at those performances, and a record of demands for electric power in the past. The processing unit 210 reads and refers to these information items as required.

Note that the information storage unit 213 may not be integrally formed with the server 200. They may be connected to each other through the Internet network 800. Further, the whole DB may not be stored in one information storage unit 213. The information storage unit 213 may be formed by a plurality of storages and these storages may store respective DBs. Further, the whole DB does not need to be formed as a part of the distribution system 100. That is, the server 200 may use DBs that belong to other systems.

The processing unit 210 also functions as a function execution unit that performs various computations and controls related to the processing. An acquisition unit 210a acquires vehicle information from the vehicle 300 through the communication IF 211 at a timing specified by the control program. Similarly, the acquisition unit 210a acquires supply facility information from each charging station 500 through the communication IF 211 and acquires production facility information from each power plant 600 through the communication IF 211.

A determination unit 210b predicts amounts of generated electricity and demands for electric power by analyzing the vehicle information, the supply facility information, and the production facility information acquired by the acquisition unit 210a. Then, the determination unit 210b determines how much electric power should be transferred from which charging station to which charging station. Further, the determination unit 210b determines how much electric power should be transferred from which power plant to which charging station. The determination unit 210b creates a transfer instruction in which these information items are described and transmits the created transfer instruction to the control panel 404 through the communication IF 211. That is, the transfer instruction is information about the amount of electric power determined by the determination unit 210b. Further, the communication IF 211 cooperates with the processing unit 210 and thereby functions as an output unit that outputs the transfer instruction.

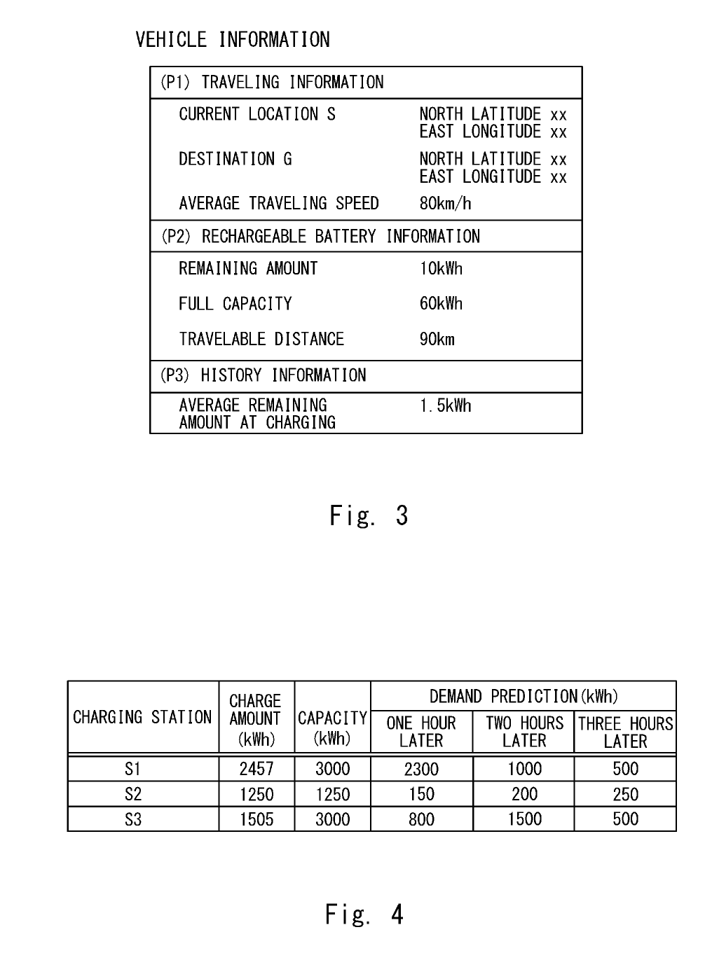

Next, specific processes performed by the acquisition unit 210a and the determination unit 210b are described. FIG. 3 shows an example of the vehicle information acquired by the acquisition unit 210a of the server 200. Each vehicle 300 creates vehicle information at regular intervals. The acquisition unit 210a acquires the created vehicle information through the Internet network 800. The acquisition unit 210a may request vehicle information when the vehicle 300 enters the target area or may simultaneously request vehicle information from each vehicle 300 traveling in the target area at regular intervals. The vehicle 300 transmits the created vehicle information to the server 200 in response to the request from the server 200.

The vehicle information includes (P1) Traveling Information, (P2) Rechargeable Battery Information, and (P3) History Information. In (P1) Traveling Information, a latitude and a longitude of a current location S identified from an output of a GPS unit, a latitude and a longitude of a destination G entered by a passenger, and an average traveling speed over one hour in the past are recorded. By using these information items, the determination unit 210b predicts which charging station the vehicle passes through together with a time at which the vehicle passes through that charging station.

In (P2) Battery Information, a remaining amount of the rechargeable battery at the present moment, a full capacity in a fully-charged state, a distance that the vehicle can travel by the remaining amount (hereinafter also referred to as a travelable distance) are recorded. The travelable distance is calculated from the remaining amount and a distance that the vehicle can travel by a unit amount of electric power. By using these information items, the determination unit 210b predicts which charging station the vehicle is likely to stop at and also predicts how much electric power needs to be supplied at the charging. In (P3) History Information, an average remaining amount at the time of charging, which is, for example, an average remaining amount of the rechargeable battery over ten times of charging in the past, is recorded. The determination unit 210b compares this information with the remaining amount in the item (P2) and thereby predicts whether the vehicle is likely to stop at the nearest charging station.

Each of the charging stations 500 creates supply facility information relevant to an amount of electric power that the charging station 500 can supply and transmits the created supply facility information to the server 200 at regular intervals. The acquisition unit 210a acquires the supply facility information from each charging station 500 at regular intervals. The supply facility information includes an amount of charged electricity at the present moment (hereinafter also referred to as a current charge amount) of each storage battery 501. When the determination unit 210b takes over (i.e., receives) the supply facility information from the acquisition unit 210a, the determination unit 210b creates station information by comprehensively analyzing the vehicle information collected from vehicles 300 traveling in the target area and the information on each charging station 500 stored in the information storage unit 213. FIG. 4 shows an example of the station information created by the determination unit 210b of the server 200.

The station information includes a current charge amount, a capacity in a fully-charged state, and a prediction of a demand for electric power in each charging station. In the example shown in FIG. 4, the prediction of the demand for electric power includes a prediction from the present moment to one hour later, a prediction from one hour later to two hours later, and a prediction from two hours later to three hours later. For example, the prediction of the demand from the present moment to one hour later in the charging station S1 is 2,300 kWh, which is a result obtained by adding up amounts of electric power required for charging rechargeable batteries of all the vehicles that are predicted to charge in the charging station S1 between the present moment to one hour later to their full capacities.

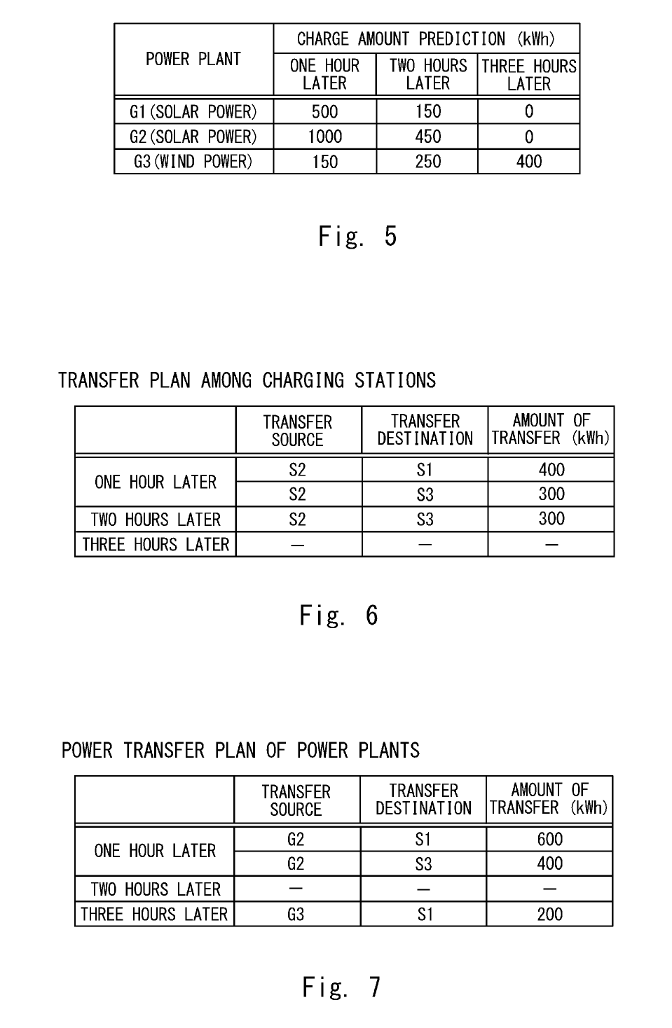

Each of the power plants 600 creates production facility information relevant to an amount of renewable energy to be generated and transmits the created production facility information to the server 200 at regular intervals. The acquisition unit 210a acquires the production facility information from each power plant 600 at regular intervals. The production facility information includes an amount of generated electricity at the present moment. When the determination unit 210b takes over (i.e., receives) the production facility information from the acquisition unit 210a, the determination unit 210b creates power plant information by comprehensively analyzing the information on each power plant 600 stored in the information storage unit 213 and the weather forecast information stored in the external DB 700. FIG. 5 shows an example of the power plant information created by the determination unit 210b of the server 200.

The power plant information includes a prediction of an amount of generated electricity in each power plant. In the example shown in FIG. 5, the prediction of the amount of generated electricity includes a prediction from the present moment to one hour later, a prediction from one hour later to two hours later, and a prediction from two hours later to three hours later. For example, a prediction of an amount of generated electricity from the present moment to one hour later in a power plant G1, which is a solar power generation plant, is 500 kWh. Further, a prediction from two hours later to three hours later is zero. This is a result of a prediction based on an electric power generating performance at the present moment and a sunset time. Further, a prediction of an amount of generated electricity from two hours later to three hours later in a power plant G3, which is a wind power generation plant, increases from a prediction of an amount of generated electricity one hour earlier (i.e., a prediction from one hour later to two hours later). This is because it is predicted that the wind will increase after the sunset based on the weather forecast information and the location of the power plant G3.

The determination unit 210b further analyzes the created station information and the power plant information and thereby draws up an electric power transfer plan between charging stations. FIG. 6 is an example of the transfer plan between charging stations. Specifically, a time period from the present moment to one hour later, a time period from one hour later to two hours later, a time period from two hours later to three hours later are defined. Then, in each time period, a charging station that is expected to have an extra amount of stored electric power, a charging station where an amount of stored electric power is expected to be tight are determined. Further, it is determined how much electric power should be transferred between these charging stations.

An example of processes for the determination is described. Firstly, based on the station information, it is confirmed that while the current charge amount of the charging station S1 is 2,457 kWh, a prediction of a demand up to one hour later is 2,300 kWh and a prediction of a demand from one hour later to two hours later is 1,000 kWh. Further, based on the power plant information, it is confirmed that a prediction of an amount of electricity generated in the power plant G1, which mainly supplies electric power to the charging station S1, in the time period up to one hour later is 500 kWh. From these facts, it is expected that the amount of electric power stored in the charging station S1 will become tight in the time period up to one hour later and in the time period from one hour later to two hours later unless electric power is transferred to the charging station S1.

Further, based on the station information, it is confirmed that while the current charge amount of the charging station S3 is 1,505 kWh, a prediction of a demand up to one hour later is 800 kWh and a prediction of a demand from one hour later to two hours later is 1,500 kWh. Further, based on the power plant information, it is confirmed that a prediction of an amount of electricity generated in the power plant G3, which mainly supplies electric power to the charging station S3, in the time period up to one hour later is 150 kWh. From these facts, it is expected that the amount of electric power stored in the charging station S3 will become tight in the time period up to one hour later and in the time period from one hour later to two hours later unless electric power is transferred to the charging station S3.

Meanwhile, based on the station information, it is confirmed that while the current charge amount of the charging station S2 is 1,250 kWh, a prediction of a demand up to one hour later is 150 kWh and a prediction of a demand from one hour later to two hours later is 2,000 kWh. From these facts, it is expected that the charging station S2 will have an extra amount of stored electric power in the time period up to one hour later and in the time period from one hour later to two hours later.

Therefore, the determination unit 210b determines to transfer electric power of 400 kWh from the charging station S2 to the charging station S1 and transfer electric power of 300 kWh from the charging station S2 to the charging station S3 in the time period from the present moment to one hour later. Further, it is also expected that the amount of electric power stored in the charging station S3 will become tight in the time period from one hour later to two hours later. Therefore, the determination unit 210b also determines to transfer electric power of 300 kWh from the charging station S2 to the charging station S3 in the time period from one hour later to two hours later. Note that the determination unit 210b determines that there is no charging station where the amount of electric power will be tight in the time period from two hours later to three hours later and hence determines that transfer of electric power will not be performed in this time period.

The determination unit 210b creates a transfer instruction in accordance with the above-described transfer plan and transmits the created transfer instruction to the control panel 404 so that the transfer of electric power will be performed in accordance with the transfer plan. Note that in this example, the station information and the power plant information up to three hours later are creased on the assumption that the transfer plan is drawn up every three hours. However, the updating period is not limited to three hours. That is, various time periods may be defined according to the configuration of the distribution system 100 and/or the traffic condition of the target area. Further, the unit time period is also not limited to one hour and various time periods may be defined as the unit time period.

The determination unit 210b further analyzes the created station information and the power plant information and thereby draws up an electric power transfer plan for the power plants. FIG. 7 shows an example of the electric power transfer plan for the power plants. Specifically, similarly to the transfer plan among charging stations, a time period from the present moment to one hour later, a time period from one hour later to two hours later, a time period from two hours later to three hours later are defined. Then, in each time period, a power plant that is expected to generate an extra amount of electric power, a charging station where an amount of stored electric power is expected to be tight are determined. Further, it is determined how much electric power should be transferred between them.

An example of processes for the determination is described. As described above, it is expected that the amount of the stored electric power will become tight in the time period up to one hour later and the time period from one hour later to two hours later in each of the charging stations S1 and S3. Further, it is determined that the amount of electric power stored in the charging station S2 will not become tight in the time period up to one hour later. Therefore, the determination unit 210b determines to transfer electric power generated in the power plant G2, which mainly supplies electric power to the charging station S2, in the time period up to one hour later to the charging stations S1 and S3. At this point, since the necessity that the power plant G2 charge the storage battery of the charging station S2 is small, the determination unit 210b determines to transfer the whole amount of electricity generated in the power plant G2 to the charging stations S1 and S3. In this example, electric power of 600 kWh and 400 kWh are allocated to the charging stations S1 and S3, respectively, in consideration of the degrees of tightness of their electric power.

The determination unit 210b determines that no transfer of electric power will be performed in the time period from one hour later to two hours later. Further, the determination unit 210b determines to transfer surplus electric power in the power plant G3 to the charging station S1 in the time period from two hours later to three hours later in which the amount of electricity generated in the power plant G3 is large.

The determination unit 210b creates a transfer instruction in accordance with the above-described transfer plan and transmits the created transfer instruction to the control panel 404 so that the transfer of electric power will be performed in accordance with the transfer plan. Note that similarly to the electric power transfer plan for the charging stations, the updating period for the electric power transfer plan for the power plants is not limited to three hours. Further, the unit time period is also not limited to one hour. Further, since electric power transfer from a power plant to a charging station is performed to supplement the electric power transfer between charging stations, it is not indispensable in the distribution system 100. Further, when electric power is transferred from a power plant to a charging station, it is possible to determine only the transfer destination of generated electric power without determining the amount of electric power to be transferred.

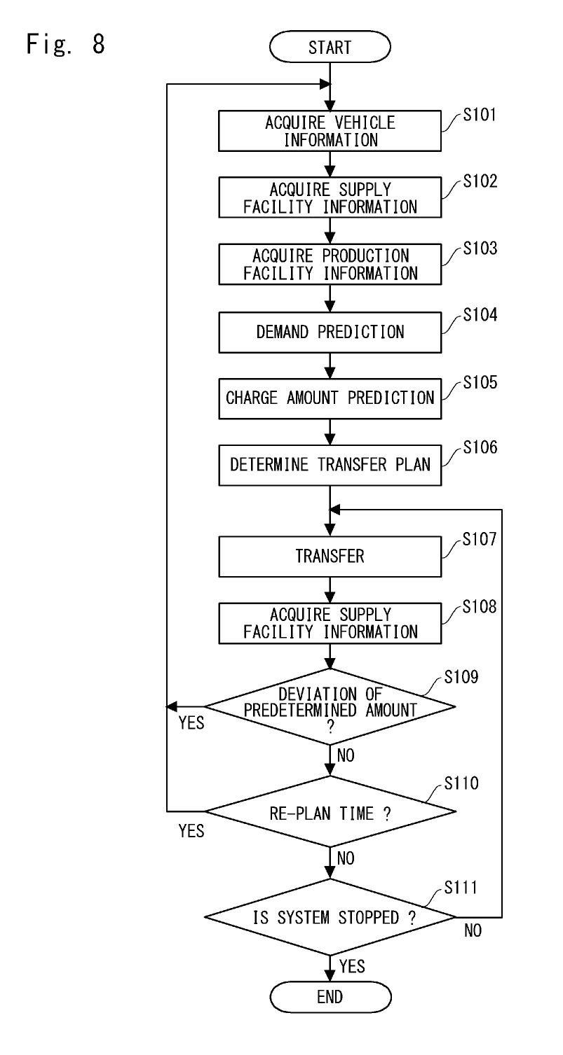

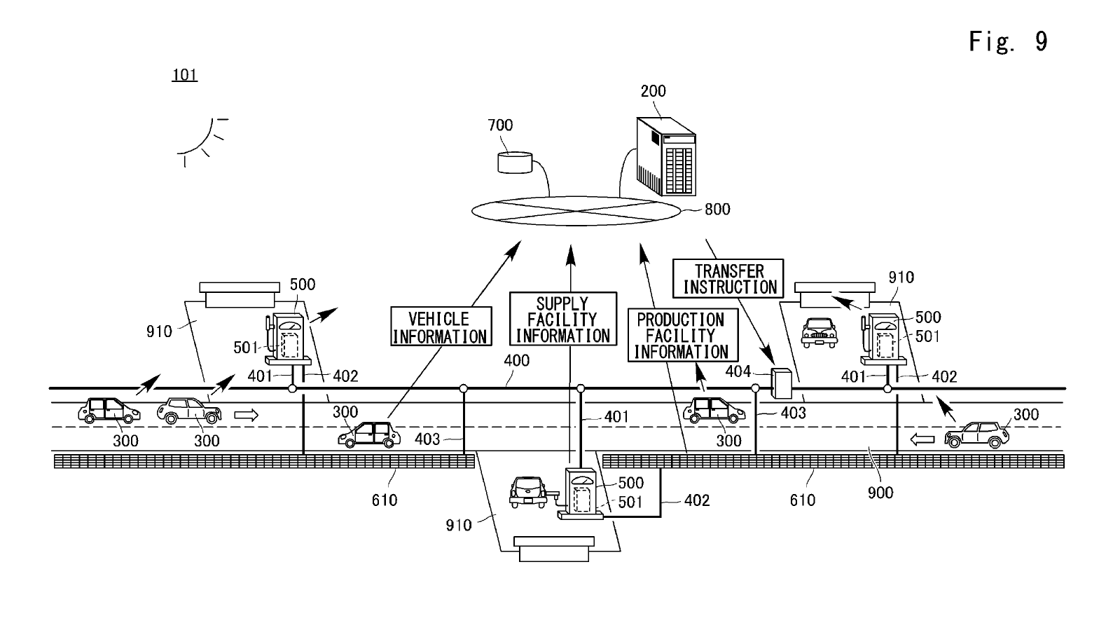

Next, a flow of a series of processes in this example is described. FIG. 8 is a flowchart showing processes performed by the server 200. In a step S101, the acquisition unit 210a acquires vehicle information from each vehicle 300. Further, in a step S102, the acquisition unit 210a acquires supply facility information from each charging station 500. Further, in a step S103, the acquisition unit 210a acquires production facility information from each power plant 600. The order of the steps S101 to S103 does not need to be the above-described order. Further, the acquisition timings are as described above.

In a step S104, the determination unit 210b predicts a demand in each charging station 500 in the target area. Specifically, the determination unit 210b creates the above-described station information by using the acquired vehicle information, the supply facility information, and information in the external DB 700, which the determination unit 210b refers to, and by using the information storage unit 213. Further, in a step S105, the determination unit 210b predicts amounts of electricity generated in the power plants 600. Specifically, the determination unit 210b creates the above-described power plant information by using the acquired production facility information, and the information in the external DB 700, which the determination unit 210b refers to, and by using the information storage unit 213. The order of the steps S104 and S105 may be reversed.

The determination unit 210b analyzes the station information created in the step S104 and the power plant information created in the step S105, and thereby determines an electric power transfer plan. Specifically, the determination unit 210b draws up the above-described electric power transfer plan among the charging stations and the electric power transfer plan for the power plants.

In a step S107, the determination unit 210b creates a transfer instruction in accordance with the drawn-up transfer plan and transmits the created transfer instruction to the control panel 404. That is, the server 200 makes the control panel 404 perform a transfer(s) of electric power according to the transfer plan. After a certain time has elapsed, the acquisition unit 210a acquires supply facility information from each charging station 500 in a step S108. Then, in a step S109, the processing unit 210 checks whether or not the predicted demand for electric power deviates from the actual demand for electric power by a predetermined amount or larger. When the deviation is equal to or larger than the predetermined amount, the process returns to the step S101 and the series of processes is performed again. When the deviation is smaller than the predetermined amount, the process proceeds to a step S110.

When the processing unit 210 proceeds to the step S110, it checks whether or not it becomes a time at which a transfer plan should be drawn up again. When it has become the time, the process returns to the step S101 and the series of processes is performed again. When it still has not become the time, the process proceeds to a step S111 and the processing unit 210 determines whether or not the system has been stopped. When the system has not been stopped, the process returns to the step S107 and the transfer of electric power is continued. When the system has been stopped, the processing unit 210 performs a termination process and thereby finishes the series of processes.

The above-described first example is described on the assumption that charging stations 500 and power plants 600, which mainly supply electric power to the charging stations, are installed in a one-to-one manner. However, one power plant 600 may supply electric power to two charging stations 500 or more. Further, the distribution system may include a charging station(s) 500 that receives electric power from a conventional power generation facility such as a thermal power generation facility, and may include a charging station(s) 500 that receives electric power from both a power plant 600 and a conventional power generation facility.

The above-described first example is described on the assumption that the speed of the transfer of electric power is constant. However, depending on the equipment in the charging station 500, the amount of electric power that the charging station 500 can receive in a unit time can be adjusted. In the case of the transfer of electric power to the charging station 500 having the above-described function, the transfer speed may be changed according to the degree of changes in the demand. In particular, when it is possible to predict a time at which a vehicle 300 arrives at a charging station 500, electric power may be transferred so as to be in time for the predicted arrival time.

In this case, the determination unit 210b predicts the time at which the vehicle 300, whose vehicle information has been acquired, arrives at the charging station and determines the transfer speed of electric power through the power transmission line 400 so that the electric power is transferred in time for the predicted arrival time. The control panel 404 transfers electric power at the determined transfer speed. In this way, when the transfer should be performed quickly, the demand from the consumer is satisfied by increasing the transfer speed. On the other hand, when transfer does not need to be performed quickly, the transfer speed is lowered to prevent the deterioration of the storage battery which would otherwise be caused due to the quick charging.

In the first example described above, an example in which the power transmission line 400, which is the transfer facility, is installed along the expressway 900 is described. In such an example, an auxiliary charging facility for urgently supplying electric power to a vehicle 300 is preferably installed in the path of the power transmission line 400. By installing such a facility, it is possible to take an emergency measure in an emergency or the like of the vehicle 300 and thereby to improve the traffic environment of the target area.

Further, the target area may not be limited to a certain section of the expressway 900. When the charging station 500 is installed in the service area 910 of the expressway 900, the demand for electric power can be accurately predicted. However, it is expected to produce some results even when the target area includes a motorway and/or an ordinary road such as a main road.

Further, in the first example described above, demands for electric power and amounts of generated electricity are predicted by using various parameters. However, all of the aforementioned parameters are not necessarily indispensable. Further, other parameters may also be taken into consideration. What kind of parameters should be taken into consideration is determined in view of the accuracy for the prediction that should be guaranteed. For example, as the vehicle information, a current location, a destination, a traveling speed, a traveling distance per unit traveling energy, and history information relevant to supplies of traveling energy are mentioned. However, which parameters should be used as the vehicle information is determined based on the specifications of the distribution system 100.

Next, a second example of this embodiment is described. FIG. 9 is a conceptual diagram showing an electric power distribution system 101 according to the second example. The distribution system 101 differs from the distribution system 100 in the arrangement of power plants. In the distribution system 100, charging stations 500 and power plants 600, which mainly supply electric power to the charging stations, are installed in a one-to-one manner. In contrast to this, in the distribution system 101, solar power generation units 610 are continuously installed along the expressway 900.

In the case where solar power generation units 610 are continuously installed as described above, the solar power generation units 610 may be divided into a plurality of sections and each section of the solar power generation units 610 may supply electric power to a corresponding charging station 500. Further, the solar power generation units 610 may be connected to the power transmission line 400 through sub transmission lines 403 at any parts of the solar power generation units 610. Similarly to the distribution system 100, the distribution system 101 can also transfer electric power.

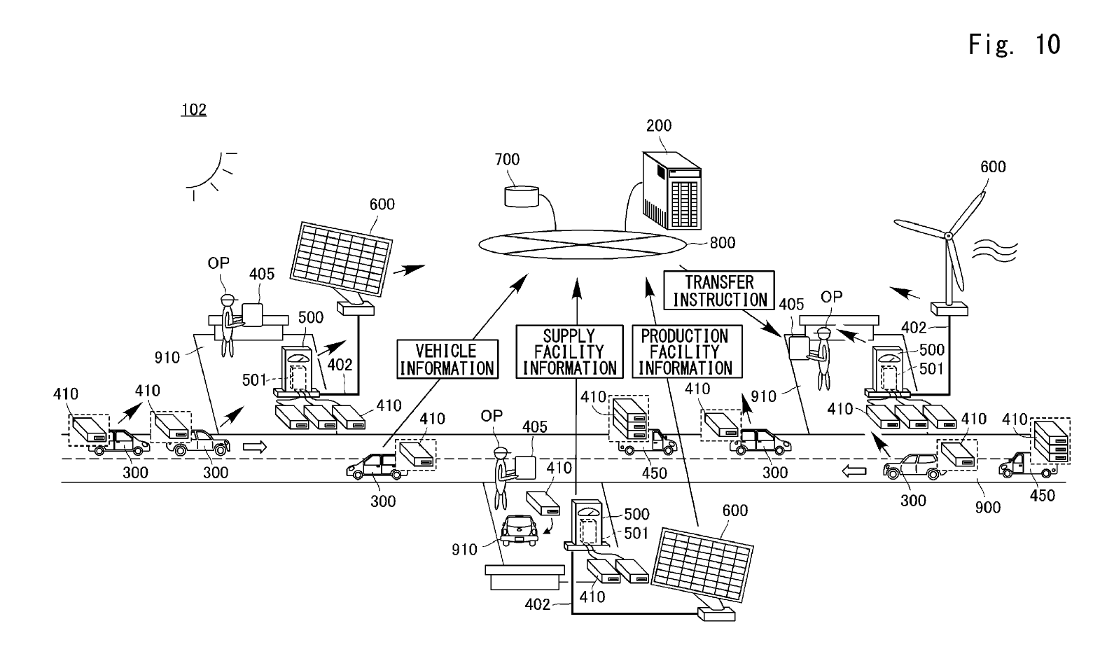

Next, a third example of this embodiment is described. FIG. 10 is a conceptual diagram showing another electric power distribution system 102 according to the third example. The distribution system 102 differs from the distribution system 100 because the distribution system 102 does not include the power transmission line 400, the drop wire 401, the sub transmission line 403, and the control panel 404, which are the transfer facility. Further, target vehicles 300 of the distribution system 102 are vehicles each of which travels by electric power supplied from a detachable storage battery module 410. Further, when the storage battery module 410 has used up all the electric power, it is replaced by a charged one. The storage battery module 410 is lent by an operator (e.g., a business proprietor). The operator charges the storage battery module 410 at the charging station 500 and receives a request from a passenger of the vehicle 300 as to whether the passenger wants to rent/replace the storage battery module 410. Therefore, the operator needs to prepare a necessary number of charged storage battery modules 410 in the charging station 500 according to the demand from the vehicles 300.

The distribution system 102 according to the third example functions in the above-described rental system. Specifically, similarly to the distribution system 100, the acquisition unit 210a acquires vehicle information, supply facility information, and production facility information. Then, the determination unit 210b creates station information. Note that it is assumed that the prediction of the demand is a prediction of the number of storage battery modules 410 in each time period. Then, in each of the charging stations 500, the number of rechargeable storage battery modules 410 is determined and a transfer plan among charging stations is drawn up. Note that the amount of the transfer is not the amount of electric power but is the number of storage battery modules 410. Further, no transfer plan for the power plants is drawn up.

The determination unit 210b uses the transfer plan among charging stations, which has been drawn up as described above, as a transfer instruction and transmits the transfer instruction to an operator terminal 405 of the operator OP. The transfer plan is displayed in the operator terminal 405. Then, the operator OP loads the specified number of storage battery modules 410 onto a transport vehicle 450 in the charging station at the designated transfer source and the transport vehicle 450 carries them to the charging station at the designated transfer destination. In this way, in the distribution system 102, electric power is stored in the storage battery modules 410 and is transferred (i.e., transported) in the form of the storage battery modules 410. Even in the above-described embodiment, it is expected that the distribution system 102 provides advantageous effects similar to those of the distribution system 100.

Further, as a modified example of the distribution system 102, the target vehicle 300 may be a vehicle that travels by supplied hydrogen energy. Similarly to electric power, hydrogen energy is an example of traveling energy by which a vehicle can travel.

In this modified example, the charging station 500 is replaced by a hydrogen supply station. The hydrogen supply station includes a hydrogen plant that generates hydrogen by using electric power supplied from a power plant 600. The generated hydrogen is stored in a hydrogen tank and supplied to a vehicle 300 according to a request. In this case, the demand to be predicted is an amount of hydrogen to be supplied. Further, the object to be transferred (i.e., transported) is a hydrogen tank storing hydrogen. The operator OP loads the specified number of hydrogen tanks onto a transport vehicle 450 in the hydrogen station at the designated transfer source and the transport vehicle 450 carries them to the hydrogen station at the designated transfer destination. Even in the above-described embodiment, it is expected that the distribution system 102 provides advantageous effects similar to those of the distribution system 100.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer through a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A traveling energy distribution system comprising:
a plurality of supply facilities each of which is able to supply traveling energy to a vehicle;
an information acquisition unit configured to acquire, from a vehicle, vehicle information relevant to an amount of traveling energy remaining in the vehicle and acquire, from each of the plurality of supply facilities, supply facility information relevant to an amount of traveling energy that can be supplied from that supply facility;
a determination unit configured to determine a transfer source supply facility and a transfer destination supply facility for traveling energy to be transferred from among the plurality of supply facilities and determine an amount of the traveling energy to be transferred based on the vehicle information and the supply facility information acquired by the information acquisition unit; and
an output unit configured to output information relevant to the amount of the traveling energy determined by the determination unit.

2. The traveling energy distribution system according to claim 1, further comprising a plurality of production facilities, each of the plurality of production facilities being configured to generate renewable energy for supplying traveling energy to at least one of the plurality of supply facilities.

3. The traveling energy distribution system according to claim 2, wherein
the information acquisition unit acquires, from each of the plurality of production facilities, production facility information relevant to an amount of renewable energy generated in that production facility, and
the determination unit determines a transfer source production facility for traveling energy from among the plurality of production facilities and determines a transfer destination supply facility for the traveling energy from among the plurality of supply facilities based on the vehicle information, the supply facility information, and the production facility information acquired by the information acquisition unit.

4. The traveling energy distribution system according to claim 1, further comprising a transfer facility configured to transfer traveling energy between a plurality of supply facilities, wherein
the transfer facility transfers an amount of traveling energy determined by the determination unit from the transfer source supply facility determined by the determination unit to the transfer destination supply facility determined by the determination unit.

5. The traveling energy distribution system according to claim 4, wherein
the determination unit predicts a time at which the vehicle, whose vehicle information has been acquired, arrives at the transfer destination supply facility and determines a speed of the transfer of traveling energy by the transfer facility based on the predicted arrival time, and
the transfer facility transfers the traveling energy according to the transfer speed determined by the determination unit.

6. The traveling energy distribution system according to claim 4, further comprising an auxiliary supply facility installed in a transfer path through which the transfer facility transfers traveling energy, the auxiliary supply facility being capable of supplying traveling energy to a vehicle, and
the transfer facility supplies traveling energy to the auxiliary supply facility.

7. The traveling energy distribution system according to claim 1, wherein the information acquisition unit further acquires, as the vehicle information, at least one of a current location, a destination, a traveling speed, a traveling distance per unit traveling energy, and history information relevant to supplies of traveling energy.

8. The traveling energy distribution system according to claim 1, wherein each of the plurality of supply facilities comprises a storage battery configured to store electric power as traveling energy.

9. The traveling energy distribution system according to claim 1, wherein each of the plurality of supply facilities comprises a hydrogen tank configured to generate hydrogen as traveling energy by using electric power and store the generated hydrogen.

10. The traveling energy distribution system according to claim 1, wherein the plurality of supply facilities are installed along a motorway.

11. A traveling energy distribution method comprising:
a vehicle information acquisition step of acquiring, from a vehicle, vehicle information relevant to an amount of traveling energy remaining in the vehicle;
a supply facility information acquisition step of acquiring, from each of a plurality of supply facilities capable of supplying traveling energy to a vehicle, supply facility information relevant to an amount of traveling energy that can be supplied from that supply facility;
a determination step of determining a transfer source supply facility and a transfer destination supply facility for traveling energy to be transferred from among the plurality of supply facilities and determine an amount of the traveling energy to be transferred based on the acquired vehicle information and the supply facility information; and
a transfer step of transferring traveling energy equivalent to the determined amount of the traveling energy from the transfer source supply facility to the transfer destination supply facility.

12. A non-transitory computer readable medium storing a traveling energy distribution program for causing a computer to execute:
a vehicle information acquisition step of acquiring, from a vehicle, vehicle information relevant to an amount of traveling energy remaining in the vehicle;
a supply facility information acquisition step of acquiring, from each of a plurality of supply facilities capable of supplying traveling energy to a vehicle, supply facility information relevant to an amount of traveling energy that can be supplied from that supply facility;
a determination step of determining a transfer source supply facility and a transfer destination supply facility for traveling energy to be transferred from among the plurality of supply facilities and determine an amount of the traveling energy to be transferred based on the acquired vehicle information and the supply facility information; and
a transfer step of transferring traveling energy equivalent to the determined amount of the traveling energy from the transfer source supply facility to the transfer destination supply facility.
